(19) United States
(12) Patent Application Publication
(10) Pub. No.: US 2016/0100017 A1
(43) Pub. Date: Apr. 7, 2016

(54) SYSTEM AND METHOD FOR FINDING PEOPLE BASED ON A RADAR USER INTERFACE

(71) Applicant: APPROACH ME, INC, Santa Clara, CA (US)

(72) Inventor: Tariq Tony GHANMA, Santa Clara, CA (US)

(21) Appl. No.: 14/875,568

(22) Filed: Oct. 5, 2015

Related U.S. Application Data
(60) Provisional application No. 62/059,350, filed on Oct. 3, 2014.

(51) Int. Cl. H04L 29/08; G06F 3/0482; G06F 3/0484

(52) U.S. Cl. CPC H04L 67/18; G06F 3/0484; G06F 3/0482

(57) ABSTRACT

A system that for facilitating people gatherings is provided. The system comprises a server configured to (a) communicate with a plurality of client devices, in order to obtain location updates from said client devices; (b) for each of said client devices, calculate relative positional information between said a client device, and the rest of the client devices; (c) transmit said positional information said client device; and (d) cause each of said a plurality of client devices to display a user-interface in which said the client device is located at a center of said user interface, and the relative position and direction of the remaining client devices from the plurality of client devices is shown by visual markers positioned around said center.

This application claims the benefit of priority to U.S. provisional patent application No. 62/059,350, entitled “SYSTEM AND METHOD FOR FINDING PEOPLE BASED ON A RADAR USER INTERFACE”, which was filed on Oct. 3, 2014.

### FIELD

Embodiments of the present invention relate to navigation.

### BACKGROUND

Today, most smartphones have a map application which can be used to provide navigation, for example in the form of turn-u-by turn directions, to a particular location. However, in other to use a map application for purposes of navigation, a street address is required.

### SUMMARY

Embodiments of the present invention disclose a technology to facilitate locating people in a dynamic manner without a street address, or a predefined map location.

### BRIEF DESCRIPTION OF THE DRAWINGS

FIG. 1 shows a deployment scenario for the ApproachMe Service, in accordance with one embodiment of the invention.

FIGS. up. 2-14 show examples of a user interface, in accordance with one embodiment of the invention.

FIG. 15 shows a flowchart of operations performed by a client device, in accordance with one embodiment of the invention.

FIGS. 16-17 shows a flowchart of operations performed by a server device, in accordance with one embodiment of the invention.

### DETAILED DESCRIPTION OF SOME EMBODIMENTS

In the following description, for purposes of explanation, numerous specific details are set forth in order to provide a thorough understanding of the invention. It will be apparent, however, to one skilled in the art that the invention may be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, embodiments of the present invention disclose a service referred to herein as the “ApproachMe Service” for descriptive convenience. Advantageously, the ApproachMe Service utilizes a radar user interface (UI) that may be used to locate people in various contexts such as at a ball game, at a theme park, at a concert, etc., as will be described.

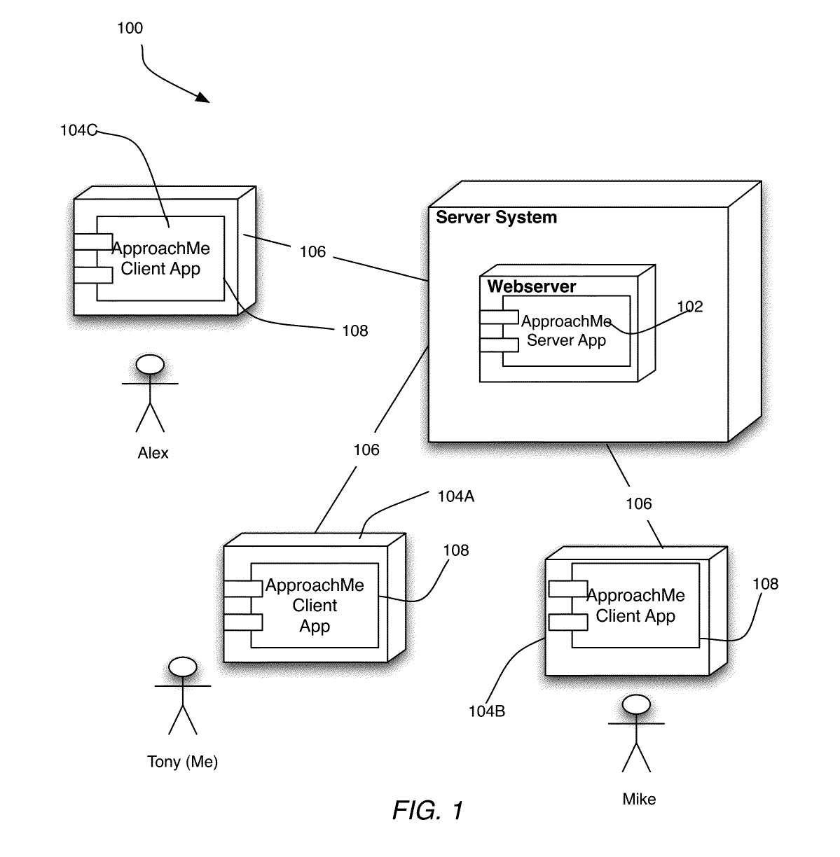

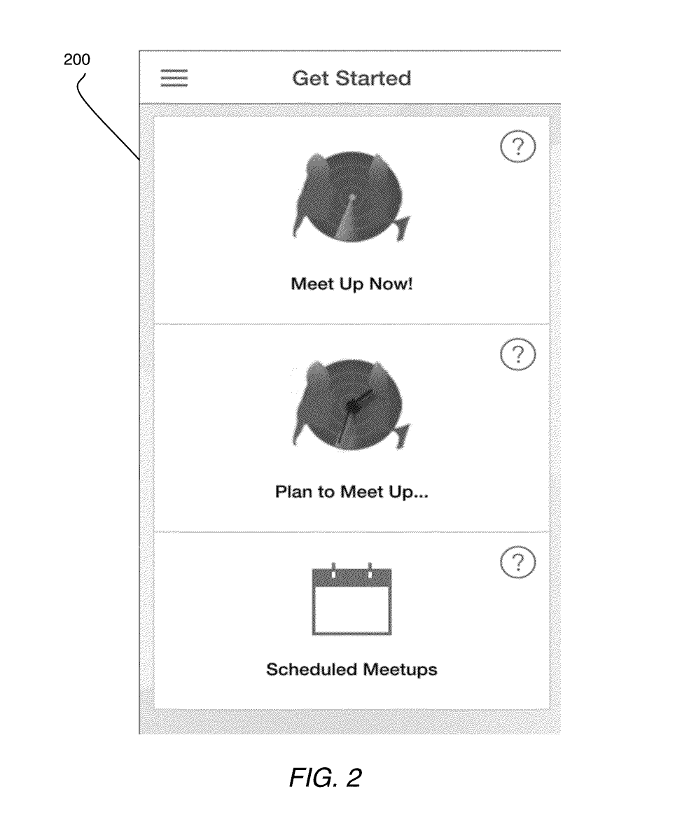

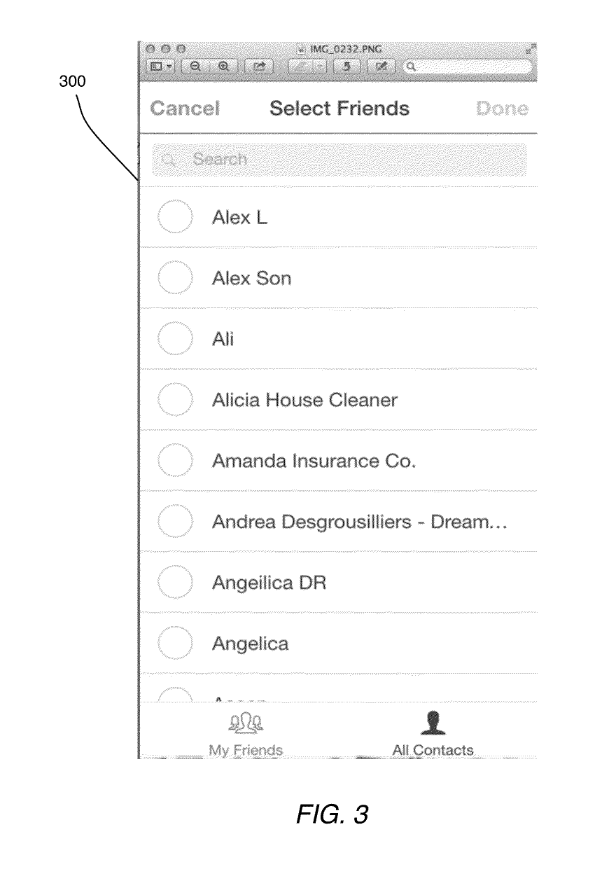

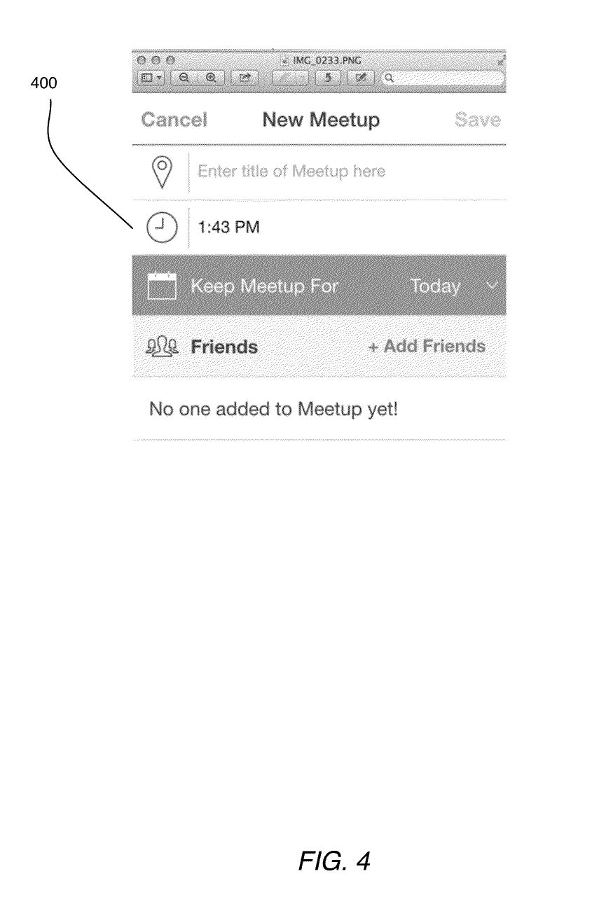

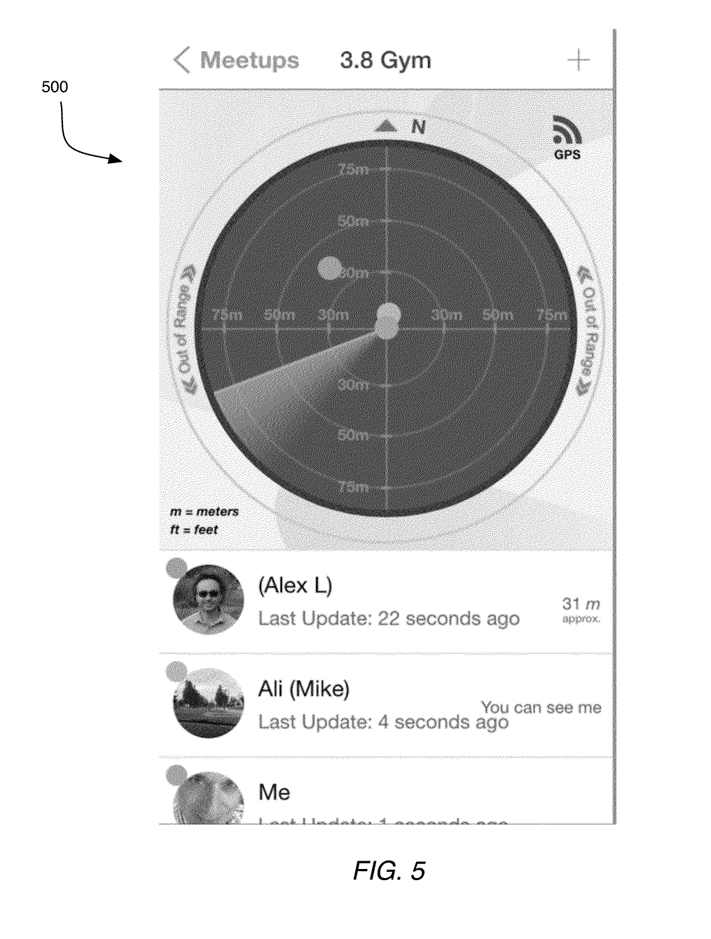

Turning now to FIG. 1 of the drawings, there is shown a deployment scenario 100 for the ApproachMe Service. AS Will be seen, the deployment scenario 100 includes an ApproachMe Server App (ASA) 102 which may be deployed in the cloud on a single server or across multiple servers and locations. In use, the ASA 102 may be communicatively coupled to a plurality of client devices 104A . . . 104N via communications links 106. Said communications links may support wireless voice and data communications. In one embodiment, the client devices may represent mobile devices such as smartphones. Each client device 104A . . . 104N may be provisioned with an ApproachMe Client App (ACA) 108. The ASA 102 and the ACA 108 may be configured to implement various aspects of the ApproachMe service, which will now be described.

To describe how the radar user interface (UI) may be used to locate people in various contexts, such as at shopping malls, at sport events, at concerts, etc., consider the various users indicated in FIG. 1 of the drawings. As can be seen, the users are Tony, Alex, and Mike. For the purposes of discussion, assume that Tony wishes to set up or facilitate a meeting with the other users Alex, and Mike. For descriptive convenience, said meeting will be referred to herein as a “meet up”. Further, events will be described from the point of view of Tony hence the word “me”, in parenthesis next to the label “Tony” in FIG. 1. Since Tony initiated the meeting request, Tony will be referred to herein as the meeting owner, whereas Alex, and Mike will be referred to herein as meeting participants.

To set up the meet up, Tony is shown a user interface such as the interface 200 of FIG. 2 as will be seen the interface 200 allows Tony to set up a meeting now, or to plan a meeting in future. Furthermore, interface 200 allows Tony to review all scheduled meet ups.

Referring now to FIG. 3, there is shown an interface 300, that may be used by Tony to select friends who will participate in the meet up.

In one embodiment, in response to Tony selecting friends for a particular meet up, each of the selected friend is sent a notification which is received via their respective ApproachMe client app. Said notification may be include options whereby each invited participant may elect to participate in a meet up, or to decline to participate. UI 1300 shown in FIG. 13 is an example of a notification, in accordance with one embodiment.

Referring now FIG. 4 of the drawings, there shown a user interface 400 which allows Tony to reschedule a particular meet up, or to add new friends to a meet up.

In one embodiment, once a meet up has been set up, and participants have joined the meet up, then each participant will be shown a radar interface, such as the interface 500 showing FIG. 5 of the drawings. In the particular case of the interface 500, the meet up is at a local gym and the participants are Alex, Mike and Tony. It is important to appreciate that the radar user interface 500 is drawn/displayed from the point of view of each meeting participant. Thus, for the user interface 500, the point of view is Tony's point of view. Similarly, Alex, Mike, and all other meeting participants will be able to view a radar user interface that is drawn from their perspective. What this allows is for each participant to view indicia denoting the location of the other participants in the meet up plotted on a radar-like screen. In the case of the interface 500, the indication for Tony is an orange colored dot which is drawn at the center location of the radar screen, and the indication for the other participants are also dots drawn on the radar screen to indicate their relative position into Tony. Thus, the dot for each other participant in the radar (here Alex, and Mike) indicates to Tony how far they are away from Tony at the present moment and also their direction of their location with respect to Tony's location. This allows Tony to navigate, e.g. usually walk, to a selected participant. It also allows the other participants to walk/navigate to each other.

Referring, to the user interface 500, for the user Mike, since he is very close to Tony, the user interface indicates to Tony that Mike is in visual range by displaying the phrase “you can see me”. However, in the case of Alex, who is indicated to be 31 meters away, there is no such guidance.

In one embodiment, the distance of each user to Tony may be indicated in a suitable unit of measurement such as feet, or meters.

FIGS. 6-10 of the drawings, show the user interface 500, with different positions for the users.

Referring to FIG. 10 it will be seen that the user interface 500 displays “chat” button. This button may be selected in order for Tony to have a conversation with Alex. The conversation may be configured to be a private conversation so that the other participants are unable to view the conversation, or it may be selected to be a public conversation so that each participant in the meet up that may be able to view said conversation.

According to various embodiments, the range of the radar may be configured to a certain preset distance, say 300 feet or any other distance as appropriate. In one embodiment, if a particular participant is outside the range, then his position is not plotted on the radar. Instead, an “out-of-range” ring is displayed peripherally around the radar and his distance and direction is indicated. Crucially, the exact location outside the radar range in not revealed. Thus, the participants can estimate an estimated time of arrival of the out of range participant, without privacy issues. In one embodiment, when an out-of range participant enters the radar range then an alert is sent to all other participants who are already within the radar range. In another embodiment, in respect of any two participants who enter within radar range of each other, an alert will be sent to each of the two participants to notify each that the other has so entered the radar range. Thus, one need not constantly monitor the radar screen.

FIG. 11 shows a user interface 1100 that includes options for user to get more details on a particular meet up or to leave a meet up.

FIG. 12 shows a user interface 1200 which provides summary information for a meet up in terms of meet up name, time, creator, date, and participants.

Referring to FIG. 13, the user interface 1300 displays a notification which is typically a type of notification sent to various participants of a meet up. In the present case, the notification is for the user Alex and it indicates that he has been invited by Tony to meet up at the gym.

FIG. 14 shows the user interface 500 updated to indicate that the user Tony has arrived at the particular meet up. In one embodiment, upon arrival of a particular participant at a meet up location, all other participants are notified of said event.

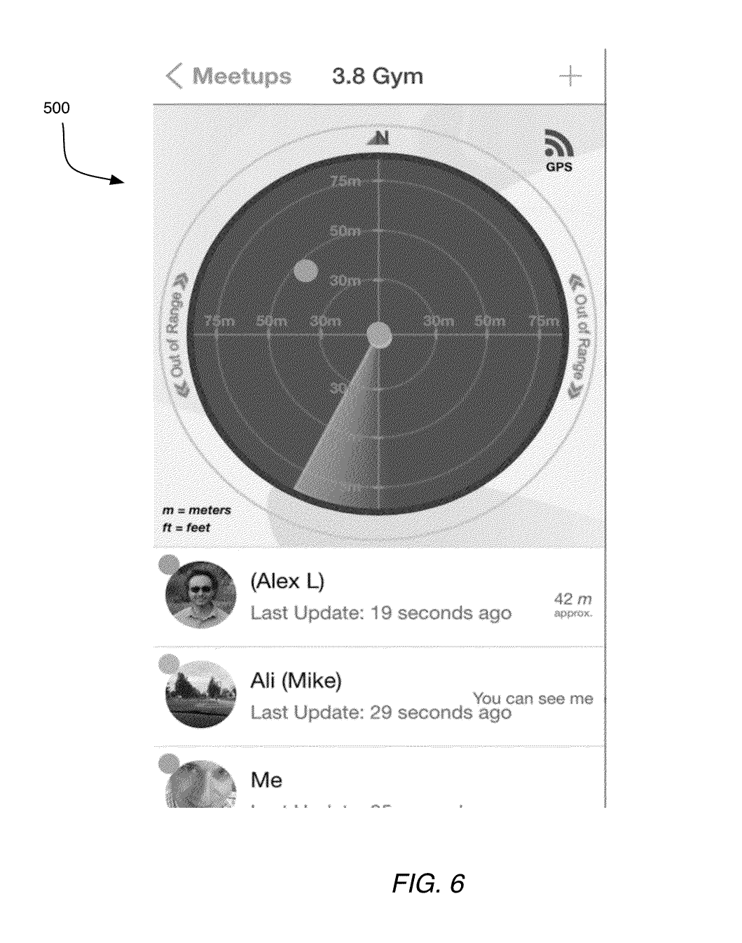

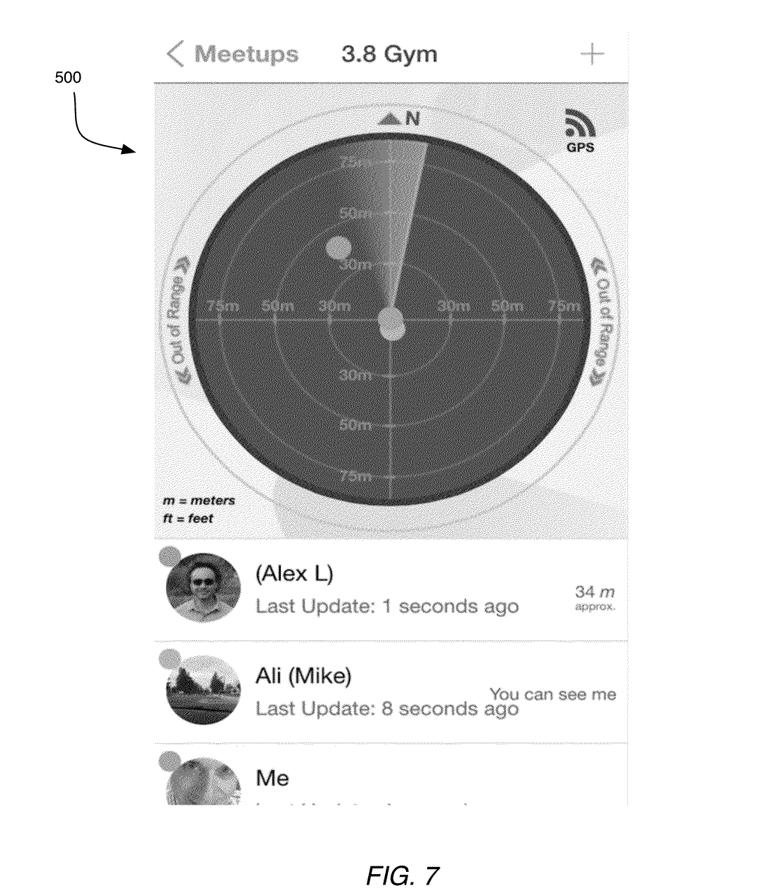

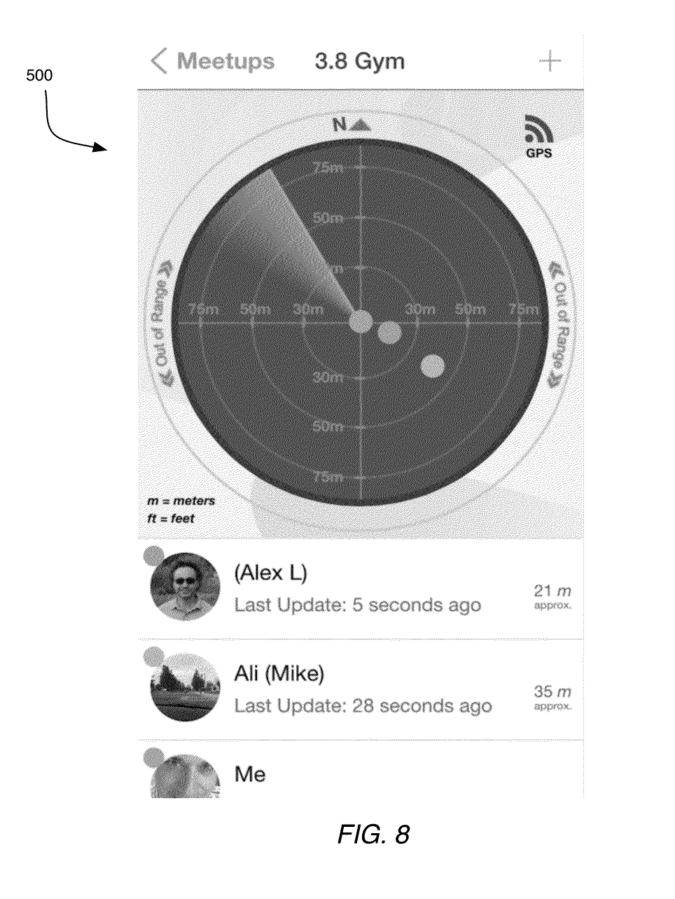

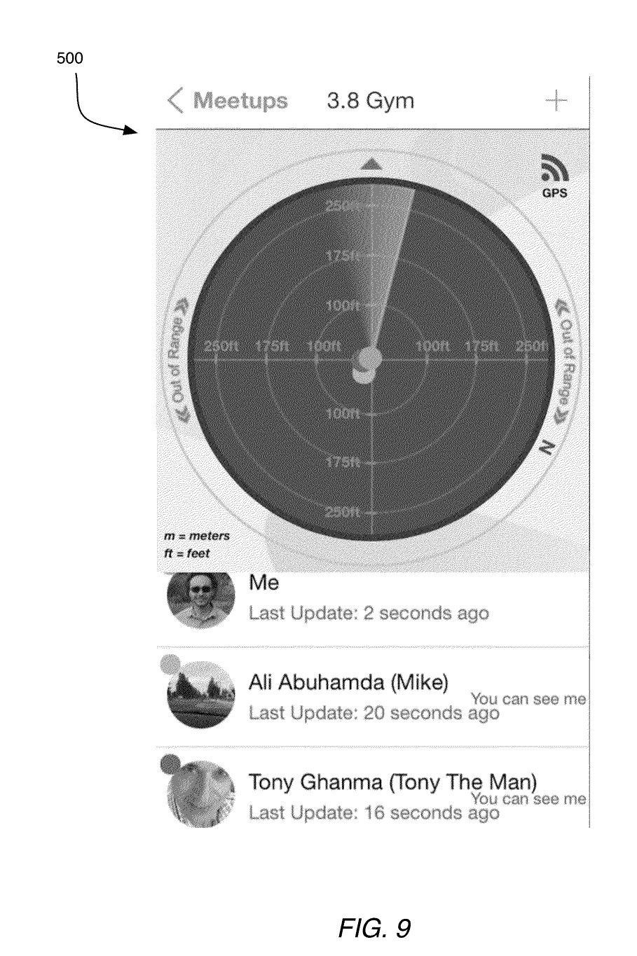

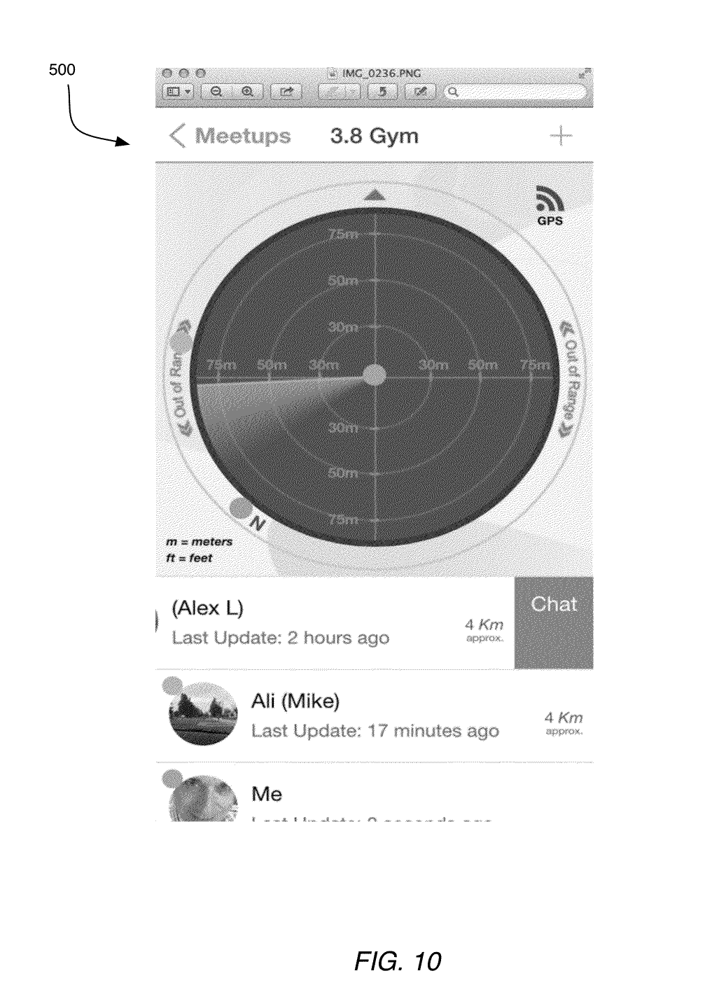

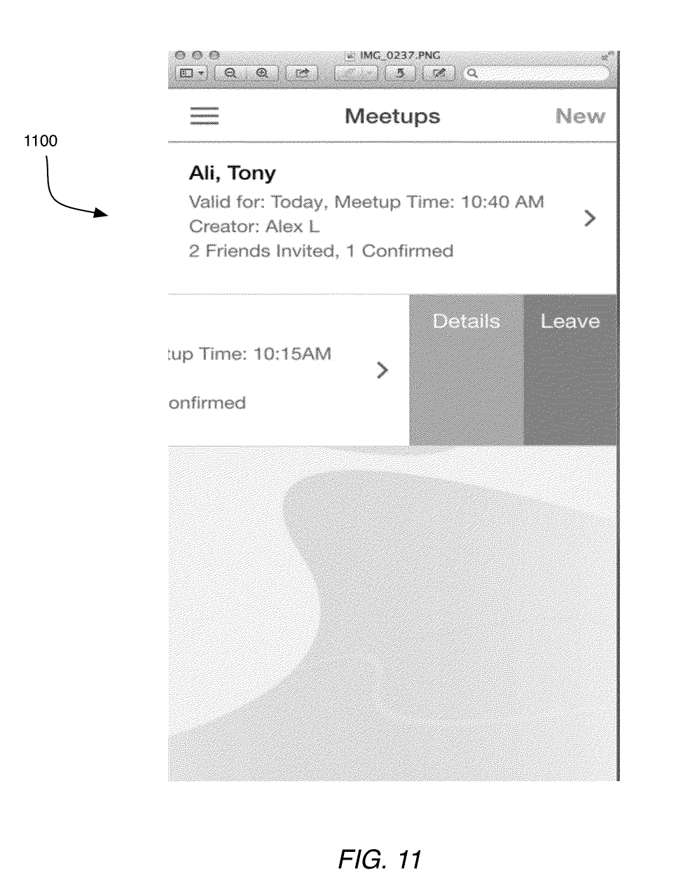

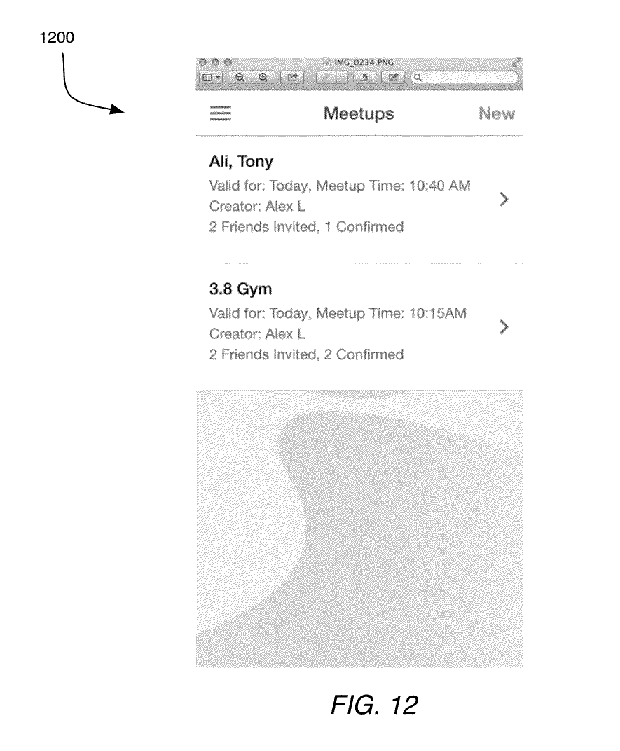

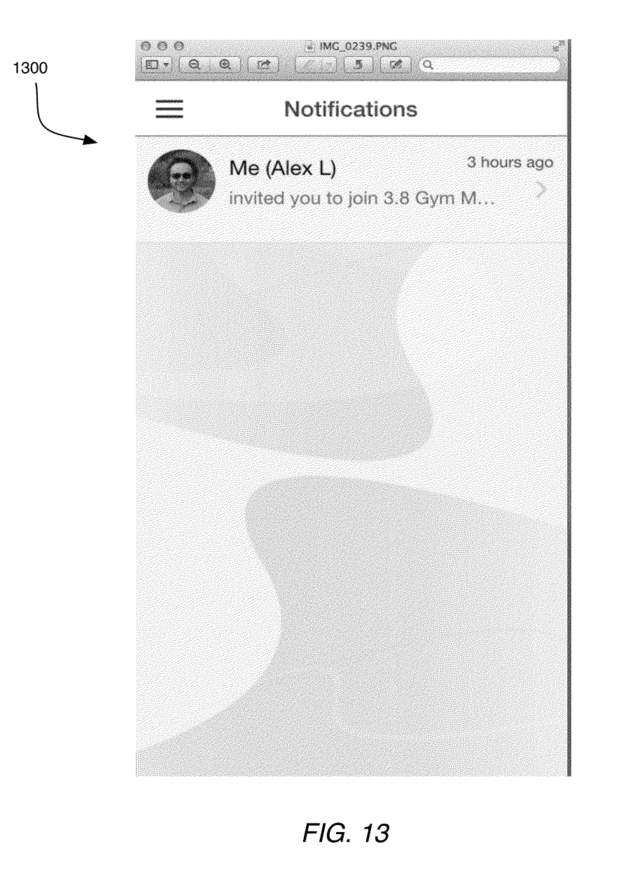

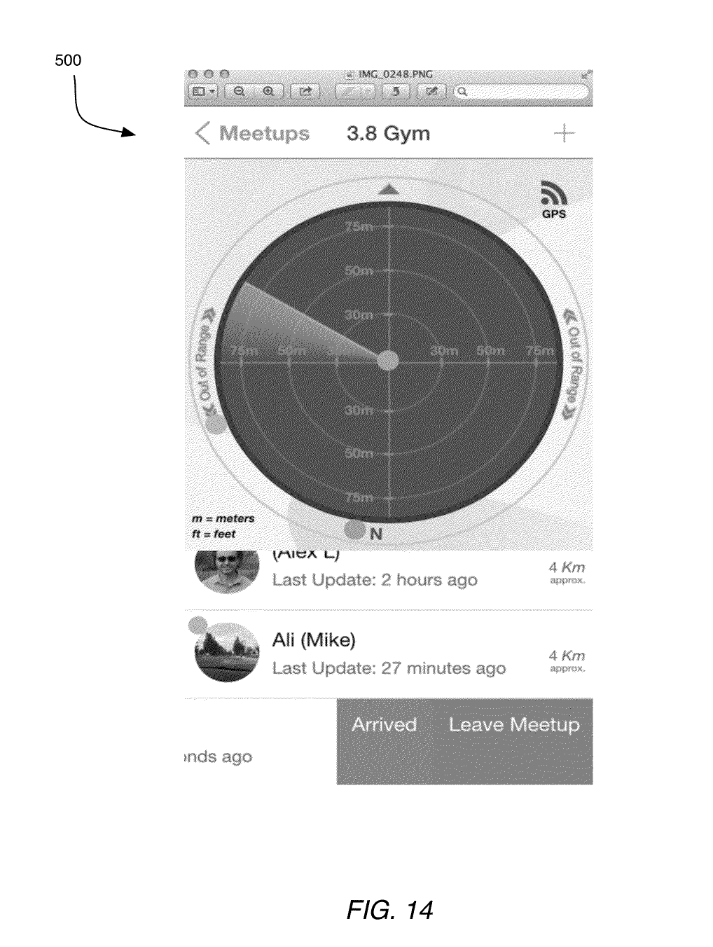

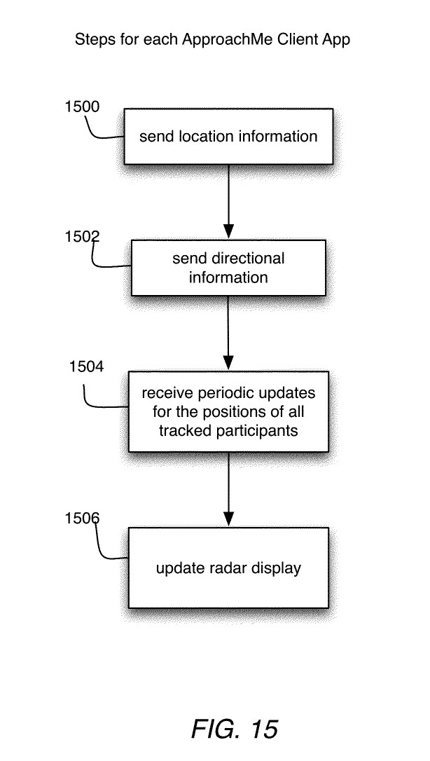

In order to support the various functions described above, each ApproachMe client app, has to send location and directional information to the ApproachMe server app. An exemplary flowchart for sending this information, in accordance with one embodiment, is shown in FIG. 15. Referring to FIG. 15, at block 1500, the ApproachMe client app sends location information to ApproachMe server app. The location information includes a location of the device on which the ApproachMe client app has been installed. Typically, the location information in the form of GPS data.

At block 1502, the ApprochMe client app sends directional information to the ApproachMe server app. This directional app information may include compass data retrieved from a compass app installed on the client device.

At block 1506, the ApprochMe app receives periodic updates for the positions of all track participants from ApproachMe server, and at block 1508 it updates its radar display.

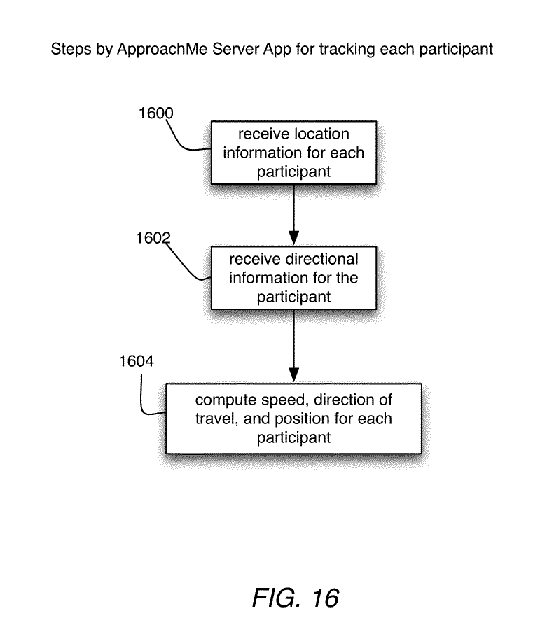

Referring now to FIG. 16 of the drawings, there is shown flowchart of operations performed by the ApproachMe server app, in one embodiment, for tracking each participant. Referring to FIG. 16, at block 1600, the ApproachMe server app receives location information for each participant. At block 1604, the ApprochMe server app receives directional information for each participant, and at block 1606 the ApproachMe server app computes a speed, direction of travel, and position for each participant. The speed for the each participant may be computed based on the GPS data received for the participant, and the direction of travel may be computed either from the GPS data itself, or from the compass information.

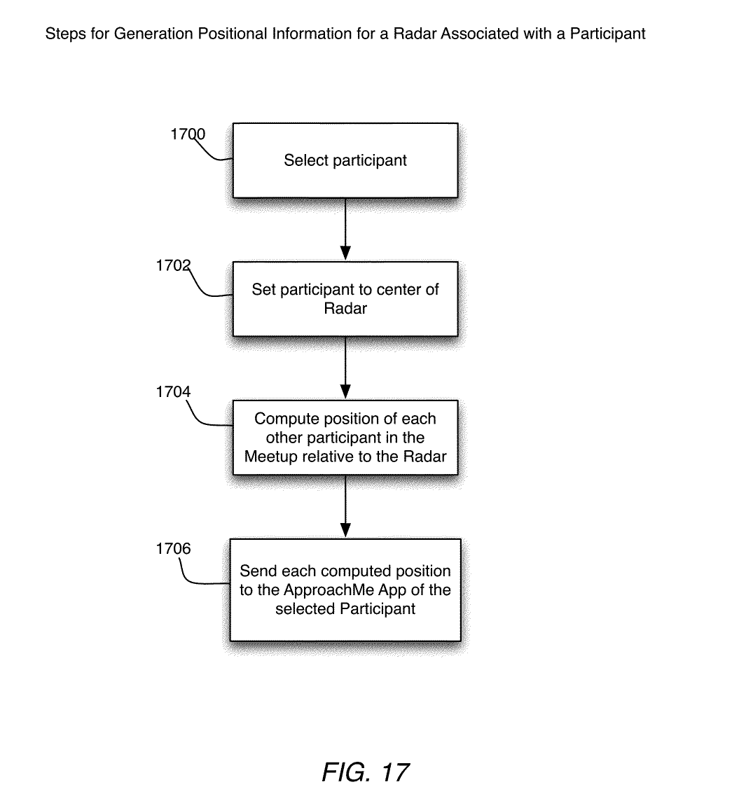

Referring to FIG. 17 of the drawings, there is shown a flow chart of operations performed by ApproachMe server app, in accordance with one embodiment, in order to generate positional information for the radar associated with each participant. To begin, at block 1700, a participant is selected, for example the participant Tony is selected. At block 1702, the participant (Tony) is set to be the center of his particular radar. At block 1704, the position of each other participant in the meet up (here Alex, and Mike) are determined or computed relative to a radar in which Tony is at the center. At block 1708, the ApproachMe server app sends each computed position to the ApproachMe app of the selected participant (here Tony). Responsive to receiving the computed positions, Tony's ApproachMe app will plot the positions of all other participants in the meet up on a radar in which Tony is at the center, as shown in the screenshots described.

Advantageously, using the technology described herein the meet up location does not have to be fixed. As participants converge towards a meet up location, the actual meeting point will dynamically and seamlessly update/change based on the movement of the participants.

Up up up Each of function of the apps describe above may be implemented as modules. As used herein, the term “module” might describe a given unit of functionality that can he performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

In general, the modules/routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), flash drives among others.

Modules might be implemented using a general-purpose or special-purpose processing engine such as, for example, a microprocessor, controller, or other control logic. In the illustrated example, the modules could be connected to a bus, although any communication medium can be used to facilitate interaction with other components of computing modules or to communicate externally.

The computing server might also include one or more memory modules, simply referred to herein as main memory. For example, preferably random access memory (RAM) or other dynamic memory, might be used for storing information and instructions to be executed by processor. Main memory might also be used for storing temporary variables or other intermediate information during execution of instructions to be executed by a processor. Computing module might likewise include a read only memory (“ROM”) or other static storage device coupled to bus for storing static information and instructions for processor.

The database module might include, for example, a media drive and a storage unit interface. The media drive might include a drive or other mechanism to support fixed or removable storage media. For example, a hard disk drive, a floppy disk drive, a magnetic tape drive, an optical disk drive, a CD, DVD or Blu-ray drive (R or RW), or other removable or fixed media drive might be provided. Accordingly, storage media might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the database module might include other similar instrumentalities for allowing computer programs or other instructions or data to be loaded into the computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The communications module might include various communications interfaces such as an Ethernet, network interface card, WiMedia, IEEE 802.XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,”“normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration

1. A system for facilitating people gatherings, comprising:
a server configured to:
(a) communicate with a plurality of client devices, in order to obtain location updates from said client devices; (b) for each of said client devices, calculate relative positional information between said a client device, and the rest of the client devices; (c) transmit said positional information said client device; and (d) cause each of said a plurality of client devices to display a user-interface in which said the client device is located at a center of said user interface, and the relative position and direction of the remaining client devices from the plurality of client devices is shown by visual markers positioned around said center.
